(19) United States
(12) Patent Application Publication
(10) Pub. No.: US 2026/0336391 A1
(43) Pub. Date: Oct. 29, 2026

(54) DRIVE DEVICE

(71) Applicant: JTEKT CORPORATION, Kariya-shi (JP)

(72) Inventors: Takaaki TSUGEKI, Kariya-shi (JP); Atsushi ANDO, Kariya-shi (JP)

(73) Assignee: JTEKT CORPORATION, Kariya-shi (JP)

(21) Appl. No.: 19/145,959

(22) PCT Filed: Feb. 14, 2023
(86) PCT No.: PCT/JP2023/005019

§ 371 Date: Jul. 7, 2025

(51) Int. Cl. B60K 17/04; B60K 7/00; F16H 57/08

(52) U.S. Cl. CPC B60K 17/046; B60K 7/0007; F16H 57/082; B60K 2007/0092; F16H 2057/085

(57) ABSTRACT

A drive device includes an electric motor, a planetary gear mechanism that reduces speed of output rotation of the electric motor, and a hub unit that supports the wheel-tire assembly. The hub unit includes an inward member including a hub flange to which the wheel-tire assembly is attached, an outward member that is fitted and fixed into an attachment hole, and plural rolling elements that are disposed between the inward member and the outward member. The planetary gear mechanism includes plural planetary gears, a carrier supporting the plural planetary gears, an internal gear portion meshing with the plural planetary gears on an outer peripheral side of the carrier, and a sun gear portion meshing with the plural planetary gears on an inner peripheral side of the carrier. The internal gear portion is provided on an inner periphery portion of the outward member.

### TECHNICAL FIELD

The present invention relates to a drive device for driving a wheel-tire assembly.

### BACKGROUND ART

As a drive system for an electric vehicle using an electric motor as a drive source, a so-called in-wheel motor system has been proposed in which wheel-tire assemblies are driven by drive devices that are disposed inside wheels of the wheel-tire assemblies. Vehicles that employ this type of drive system have high acceleration response because distance between the drive source and the wheel-tire assembly is short, and turning ability can also be improved by independently controlling drive force of the right and left wheel-tire assemblies.

For example, Patent Document 1 describes an in-wheel motor drive device in which a motor unit that generates a driving force, a reducer that reduces rotation of the motor unit and performs output thereof, and a hub that transmits output from the reducer to a drive wheel, are disposed coaxially on a rotational axis of the wheel-tire assembly.

### CITATION LIST

### Patent Literature

Patent Document 1: JP 2016-60286 A

### SUMMARY OF INVENTION

### Technical Problem

A drive device that is disposed inside a wheel of a wheel-tire assembly is required to be small in size, in order to avoid interference with the wheel, suspension arm of a suspension system, and the like. In view of the above, an object of the present invention is to provide a drive device that can be made compact.

### Solution to Problem

In order to archive the above object, the present invention provides a drive device that is attached to an attachment member including an attachment hole that is formed coaxially with a rotation axis of a wheel-tire assembly, and that drives the wheel-tire assembly, the drive device including an electric motor, a planetary gear mechanism that reduces speed of output rotation of the electric motor, and a hub unit that supports the wheel-tire assembly, in which the planetary gear mechanism and the hub unit are coaxially disposed in an axial direction along the rotation axis, the hub unit includes an inward member including a hub flange to which the wheel-tire assembly is attached, an outward member that is fitted and fixed into the attachment hole, and plural rolling elements that are disposed between the inward member and the outward member, the outward member extending around an outer periphery of the planetary gear mechanism, the planetary gear mechanism includes plural planetary gears, a carrier supporting the plural planetary gears, an internal gear portion meshing with the plural planetary gears on an outer peripheral side of the carrier, and a sun gear portion meshing with the plural planetary gears on an inner peripheral side of the carrier, the carrier being linked to the inward member so as not to rotate relative to the inward member, and the internal gear portion is provided on an inner periphery portion of the outward member.

### Advantageous Effects of Invention

The drive device according to the present invention can be made compact.

### BRIEF DESCRIPTION OF DRAWINGS

FIG. 1 is a perspective view illustrating a drive device, a wheel-tire assembly, an attachment member, a brake disc, and a brake device, according to an embodiment of the present invention.

FIG. 2 is a cross-sectional view of the drive device and surroundings thereof.

FIG. 3 is a partially enlarged view of FIG. 2.

FIG. 4 is a perspective view illustrating a holding member and one support shaft member.

FIG. 5 is a perspective view illustrating a linking member.

FIG. 6 is a cross-sectional view of the drive device, viewing a cross section of a planetary gear mechanism perpendicular to an axial direction from a vehicle inner side toward a vehicle outer side.

FIG. 7 is a perspective cross-sectional view illustrating an outward member.

### DESCRIPTION OF EMBODIMENTS

### Embodiment

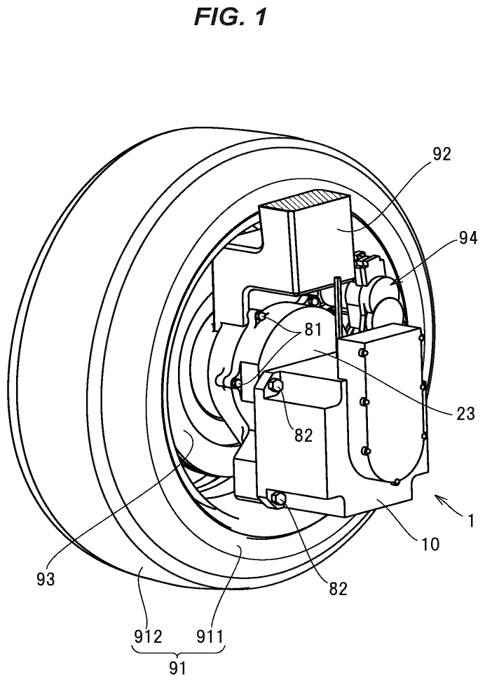

An embodiment of the present invention will be described with reference to FIGS. 1 to 7. Note that the embodiment described below is given as a preferred specific example of carrying out the present invention, and includes portions that specifically exemplify various technical matters that are technically preferable, but the technical scope of the present invention is not limited to this specific embodiment.

FIG. 1 is a perspective view illustrating a drive device 1 according to the embodiment of the present invention, a wheel-tire assembly 91 that is driven by the drive device 1, an attachment member 92 to which the drive device 1 is attached, a brake disc 93 that rotates integrally with the wheel-tire assembly 91, and a brake device 94. The wheel-tire assembly 91 has a wheel 911 that is made of metal and a rubber tire 912 that is attached to the wheel 911. The attachment member 92 is linked to a vehicle body of a vehicle via a suspension arm, a shock absorber, and a suspension spring. The brake device 94 generates braking force by pressing a brake pad against the brake disc 93.

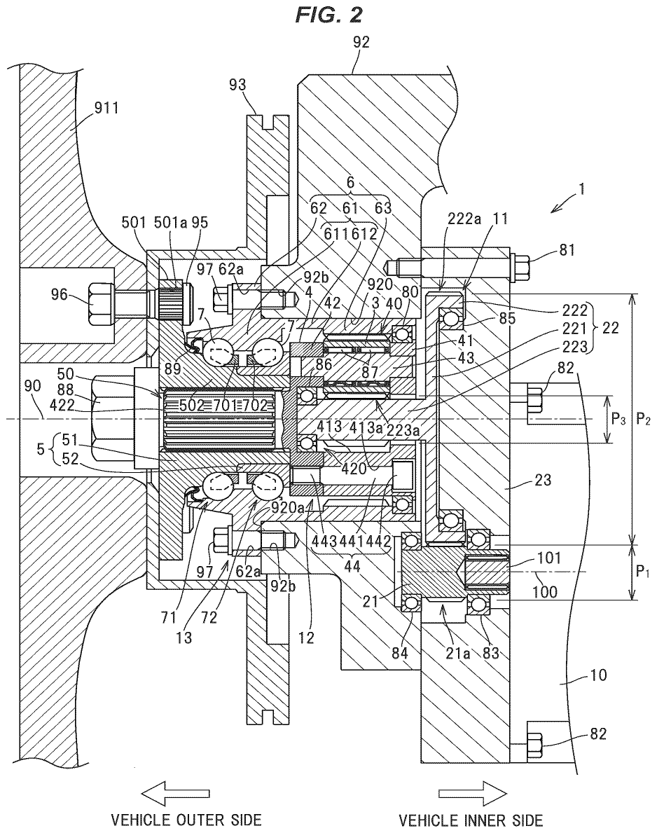

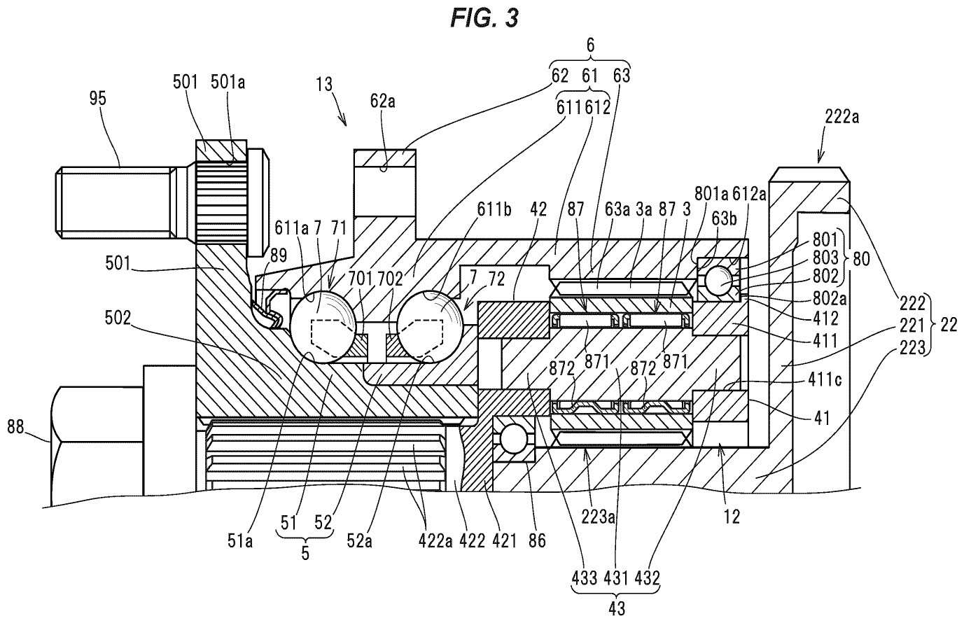

FIG. 2 is a cross-sectional view of the drive device 1 and surroundings thereof. FIG. 3 is a partially enlarged view of FIG. 2. In FIG. 2, a rotation axis 90 of the wheel-tire assembly 91 is indicated by a long dashed short dashed line. Hereinafter, a direction parallel to the rotation axis 90 will be referred to as axial direction, and a direction perpendicular to the axial direction will be referred to as radial direction. Also, the wheel-tire assembly 91 side of the attachment member 92 will be referred to as vehicle outer side, and the opposite side thereof will be referred to as vehicle inner side. The attachment member 92 has an attachment hole 920 that is formed for attaching the drive device 1. The attachment hole 920 is a circular hole that is formed coaxially with the rotation axis 90, and passes through the attachment member 92 in the axial direction.

The drive device 1 includes, as functional components thereof, an electric motor 10, a primary reduction mechanism 11 and a planetary gear mechanism 12 that reduce speed of output rotations of the electric motor 10, and a hub unit 13 that supports the wheel-tire assembly 91. The planetary gear mechanism 12 and the hub unit 13 are disposed coaxially and are aligned in the axial direction with the rotation axis 90 as the center thereof. The primary reduction mechanism 11 is provided between the electric motor 10 and the planetary gear mechanism 12. The planetary gear mechanism 12 functions as a secondary reduction mechanism, and further reduces the output rotation of the electric motor 10, which has been reduced by the primary reduction mechanism 11, and performs transmission thereof to the hub unit 13.

Also, the drive device 1 has, as main components thereof, a pinion gear 21 that is attached to an output shaft 101 of the electric motor 10, a reduction rotation member 22 that rotates about the rotation axis 90, a cover 23 that covers the reduction rotation member 22, plural planetary gears 3, a carrier 4 that supports the plural planetary gears 3, an inward member 5 that rotates integrally with the carrier 4, an outward member 6 that is fitted and fixed to the attachment hole 920, plural rolling elements 7 that are disposed between the inward member 5 and the outward member 6, and an end portion bearing 80 that is disposed at an end portion of the outward member 6 on the vehicle inner side and supports the carrier 4 so as to be rotatable relative to the outward member 6.

The cover 23 is fixed to the attachment member 92 by plural bolts 81. FIG. 2 illustrates one of these bolts 81. The electric motor 10 is, for example, an interior permanent magnetic synchronous motor or a surface permanent magnet synchronous motor, and is fixed to the cover 23 by plural bolts 82. The rotation axis 100 of the electric motor 10 is parallel to the rotation axis 90, and is offset relative to the rotation axis 90. In the present embodiment, in a state in which the drive device 1 is installed the vehicle, the rotation axis 100 of the electric motor 10 is offset downward in a vertical direction from the rotation axis 90.

The primary reduction mechanism 11 is made up of the pinion gear 21 and a part of the reduction rotation member 22. The planetary gear mechanism 12 is made up of a part of each of the carrier 4, the plural planetary gears 3, the reduction rotation member 22, and the outward member 6. The hub unit 13 is made up of the inward member 5, the plural rolling elements 7, and a part of the outward member 6. Each of the components of the drive device 1 will be described below in detail.

The pinion gear 21 is attached to the output shaft 101 of the electric motor 10 so as to be non-rotatable relative to the output shaft 101, and is rotatably supported by a bearing 83 that is held by the cover 23 and a bearing 84 that is held by the attachment member 92. The pinion gear 21 has a small-diameter gear portion 21a that is made of a spur gear, between the bearing 83 and the bearing 84. FIG. 2 illustrates a pitch diameter P₁ of the small-diameter gear portion 21a.

The reduction rotation member 22 integrally has a disk portion 221 that is disk-shaped and is centered on the rotation axis 90, an outer peripheral cylindrical portion 222 extending in the axial direction from an outer peripheral end portion of the disk portion 221 toward the vehicle inner side, and a shaft portion 223 extending in the axial direction from a center portion of the disk portion 221 toward the vehicle outer side. The outer peripheral cylindrical portion 222 is supported by the cover 23 via a bearing 85 that is disposed inside thereof. A large-diameter gear portion 222a, that meshes with the small-diameter gear portion 21a of the pinion gear 21, is formed on the outer peripheral cylindrical portion 222. A sun gear portion 223a that makes up a part of the planetary gear mechanism 12 is formed on an outer periphery of the shaft portion 223. The sun gear portion 223a rotates integrally with the large-diameter gear portion 222a.

The large-diameter gear portion 222a of the reduction rotation member 22 is a spur gear of which tooth traces are parallel to the axial direction, similar to the small-diameter gear portion 21a of the pinion gear 21. A pitch diameter P₂ of the large-diameter gear portion 222a is formed so as to be larger than the pitch diameter P₁ of the small-diameter gear portion 21a. The primary reduction mechanism 11 is made up of the small-diameter gear portion 21a of the pinion gear 21 meshing with the large-diameter gear portion 222a of the reduction rotation member 22, and the reduction rotation member 22 rotates at a slower speed and with a higher torque than the output shaft 101 of the electric motor 10.

The shaft portion 223 of the reduction rotation member 22 is disposed at a center portion of the carrier 4. The sun gear portion 223a has helical teeth of which tooth traces are inclined with respect to the axial direction, and meshes with the plural planetary gears 3. A pitch diameter P₃ of the sun gear portion 223a is formed smaller than the pitch diameter P₂ of the large-diameter gear portion 222a. The carrier 4 has a holding member 41 in which plural holding portions 40 are formed that respectively holds the plural planetary gears 3, a linking member 42 that suppresses the planetary gears 3 from slipping out of the holding portions 40 and also links the holding member 41 to the inward member 5, plural support shaft members 43 that are disposed between the holding member 41 and the linking member 42 and supports each of the plural planetary gears 3, and plural bolts 44 that fix the holding member 41 to the linking member 42.

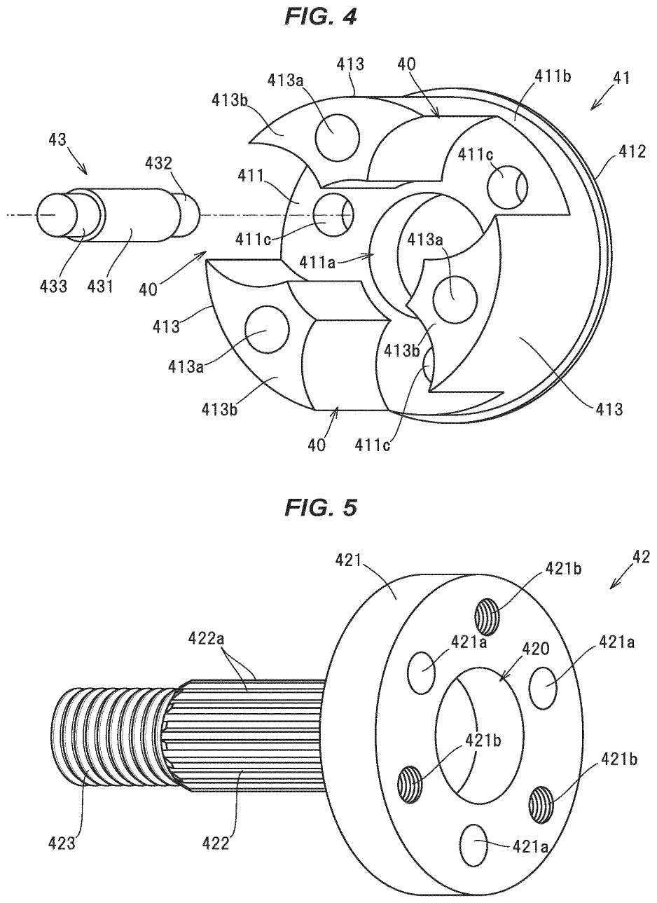

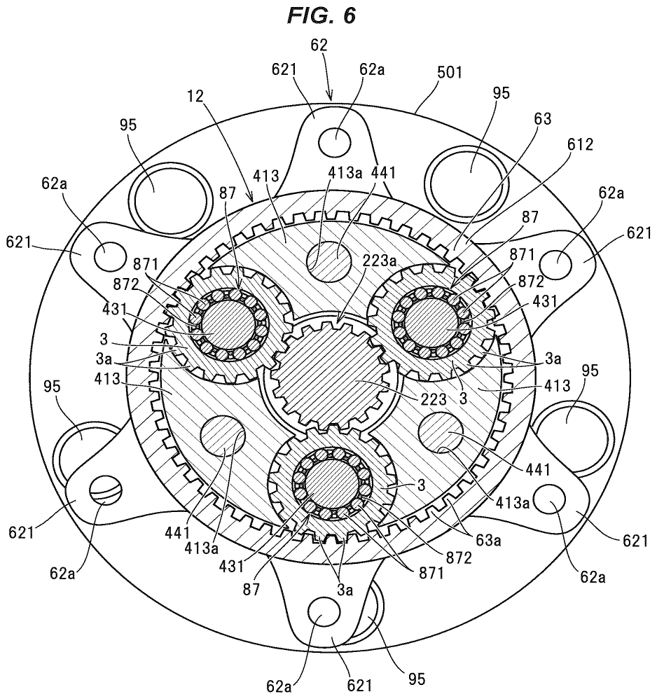

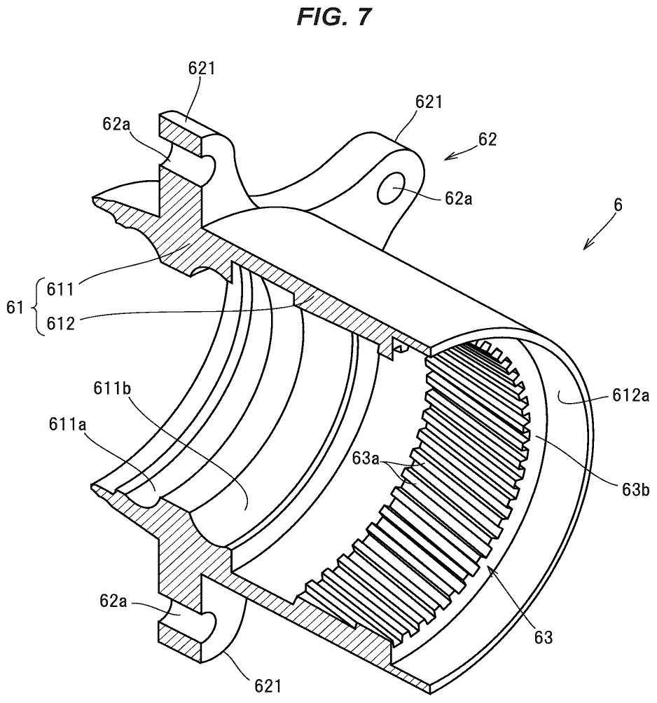

FIG. 4 is a perspective view illustrating the holding member 41 and one support shaft member 43. FIG. 5 is a perspective view illustrating the linking member 42. FIG. 6 is a cross-sectional view of the drive device 1, viewing a cross section of the planetary gear mechanism 12 perpendicular to the axial direction from the vehicle inner side toward the vehicle outer side. FIG. 7 is a perspective cross-sectional view illustrating the outward member 6.

The holding member 41 integrally has a base portion 411 that is disk-shaped and is centered on the rotation axis 90, a flange portion 412 that is provided at the vehicle inner side end portion of the base portion 411, and plural leg shaft portions 413 that are formed extending in the axial direction from the base portion 411 so as to protrude toward the vehicle outer side. A through hole 411a is formed in a center portion of the base portion 411, into which the shaft portion 223 of the reduction rotation member 22 is inserted. The flange portion 412 is formed in an annular shape and protrudes in the radial direction from an outer peripheral face 411b of the base portion 411.

The plural leg shaft portions 413 are provided at equal intervals along a circumferential direction, centered on the rotation axis 90, and the holding portions 40 are formed between the plural leg shaft portions 413. In the present embodiment, the planetary gear mechanism 12 has three planetary gears 3, and the holding member 41 is provided with three leg shaft portions 413. Each leg shaft portion 413 is formed with a bolt insertion hole 413a for inserting a bolt 44 therethrough. As illustrated in FIG. 2, the bolt 44 has a insertion portion 441 that is cylindrical and is inserted into the bolt insertion hole 413a, a head portion 442 that has a larger diameter than the insertion portion 441, and an external thread portion 443 that screws into the linking member 42.

The support shaft member 43 integrally includes a large diameter portion 431 that is inserted into a center portion of the planetary gear 3, and a pair of small diameter portions 432 and 433 that are provided on both end portions of the large diameter portion 431. The base portion 411 of the holding member 41 is formed with a fitting hole 411c into which the small diameter portion 432 on the vehicle inner side of the pair of small diameter portions 432 and 433 of the support shaft member 43 fits. The small diameter portion 433 on the vehicle outer side fits into a fitting hole 421a of the linking member 42, which will be described next.

The linking member 42 integrally has a cap portion 421 that is disk-shaped and closes the openings on the vehicle outer side of the plural holding portions 40 and suppresses the plural planetary gears 3 from falling out, a spline shaft portion 422 which extends from a center portion of the cap portion 421 to the vehicle outer side, and an external thread portion 423 which is provided at the end portion on the vehicle outer side. A recessed portion 420 that is recessed in the axial direction toward the vehicle outer side is formed in the center portion of the cap portion 421. As illustrated in FIG. 2, the recessed portion 420 accommodates a bearing 86 that supports the shaft portion 223 of the reduction rotation member 22.

The cap portion 421 is formed with plural fitting holes 421a into which the small diameter portions 433 on the vehicle outer side of the support shaft members 43 fit, and plural screw holes 421b into which the external thread portions 443 of the bolts 44 screw. The plural fitting holes 421a and the plural screw holes 421b are arrayed alternately along the circumferential direction of the cap portion 421. A distal end face 413b of the leg shaft portion 413 abuts against the cap portion 421 of the linking member 42 under axial force of the bolt 44. Plural spline teeth 422a extending in the axial direction are formed on an outer periphery of the spline shaft portion 422. The spline shaft portion 422 is inserted into a center portion of the inward member 5.

As illustrated in FIG. 3, the planetary gear 3 is supported on an outer peripheral side of the large diameter portion 431 of the support shaft member 43 via a bearing 87. The bearing 87 is a needle roller bearing, and has plural needle rollers 871 and cages 872 that hold the plural needle rollers 871. In the present embodiment, the two bearings 87 are disposed between the large diameter portion 431 of the support shaft member 43 and the planetary gear 3.

The outward member 6 extends around an outer periphery of the planetary gear mechanism 12. An internal gear portion 63 that meshes with the plural planetary gears 3 is provided on an inner periphery portion of the outward member 6. The planetary gear mechanism 12 is made up of the plural planetary gears 3, the carrier 4, the internal gear portion 63 that meshes with the plural planetary gears 3 on an outer periphery of the carrier 4, and the sun gear portion 223a of the reduction rotation member 22 that meshes with the plural planetary gears 3 on an inner periphery of the carrier 4. The configuration of the outward member 6 will be described in detail later.

The inward member 5 is made up of a hub ring 51 having a fitting hole 50 formed in the center portion thereof, into which the spline shaft portion 422 of the linking member 42 is spline-fitted, and an inner ring 52 fitted onto an end portion of the vehicle inner side of the hub ring 51. A nut 88 is screwed onto the external thread portion 423 of the linking member 42 that protrudes from the fitting hole 50 towards the vehicle outer side. The carrier 4 is linked to the inward member 5 so as not to rotate relative to the inward member 5 by spline-fitting of the spline shaft portion 422 of the linking member 42 into the fitting hole 50.

The inner ring 52 is suppressed from falling off the hub ring 51 by the cap portion 421 of the linking member 42 abutting. Note that an end portion of the hub ring 51 on the vehicle inner side may be crimped to keep the inner ring 52 from coming off.

The plural rolling elements 7 are disposed between the inward member 5 and the outward member 6 to form double rows of rolling elements. More specifically, the plural rolling elements 7 form a first rolling element row 71 on the wheel-tire assembly 91 side and a second rolling element row 72 on the planetary gear mechanism 12 side. The plural rolling elements 7 of the first rolling element row 71 are held in a first cage 701 and roll on a first inner raceway face 51a that is formed in the hub ring 51. The plural rolling elements 7 of the second rolling element row 72 are held in a second cage 702 and roll on a second inner raceway face 52a that is formed in the inner ring 52. In the present embodiment, the rolling elements 7 are spherical, but this is not restrictive, and the rolling elements 7 may be tapered rollers.

The inward member 5 has a hub flange 501 to which the wheel 911 of the wheel-tire assembly 91 is attached, and a hub cylindrical portion 502 that on the inner side of the first rolling element row 71 and the second rolling element row 72. The hub flange 501 is a part of the hub ring 51. The hub cylindrical portion 502 is made up of a part of the hub ring 51 and the inner ring 52. The first inner raceway face 51a and the second inner raceway face 52a are formed on an outer periphery of the hub cylindrical portion 502.

A hub bolt 95 for attaching the brake disc 93 and the wheel 911 of the wheel-tire assembly 91 is fixed to the hub flange 501. The hub bolt 95 is press-fitted into a bolt hole 501a that is formed in the hub flange 501, and a hub nut 96 is screwed onto a distal end portion thereof. Note that an internal threaded hole may be formed in the hub flange 501 and the hub bolt may be screwed into this internal threaded hole.

The outward member 6 has a cylindrical portion 61 that fits into an attachment hole 920 of the attachment member 92, a flange portion 62 that is fixed to an opening end face 920a of the attachment hole 920 of the attachment member 92, and an internal gear portion 63 that is provided on the inner side of the cylindrical portion 61. In the present embodiment, the cylindrical portion 61, the flange portion 62, and the internal gear portion 63 are integrally formed. However, this is not restrictive, and the cylindrical portion 61 and the internal gear portion 63 may be separate bodies and linked to each other by, for example, spline fitting so as to be non-rotatable relative to each other. In other words, the internal gear portion 63 may be provided integrally with the cylindrical portion 61 inside the cylindrical portion 61, or may be disposed so as to rotate integrally with the cylindrical portion 61 inside the cylindrical portion 61.

The cylindrical portion 61 is formed such that the outside diameter thereof is slightly smaller than the bore diameter of the attachment hole 920, and is inserted into the attachment hole 920 from the vehicle outer side toward the vehicle inner side. The cylindrical portion 61 has a first portion 611 that is on an outer side of the hub cylindrical portion 502 of the inward member 5, and a second portion 612 that is closer to the vehicle inner side than the first portion 611. A seal member 89 is disposed between the end portion of the first portion 611 on the vehicle outer side and the hub ring 51. A portion of the first portion 611 in the axial direction is accommodated in the attachment hole 920. The entirety of the second portion 612 is accommodated in the attachment hole 920 and is disposed on the outer periphery of the holding member 41 and the cap portion 421 of the linking member 42.

The hub unit 13 is made up of the inward member 5, the flange portion 62 and the first portion 611 of the cylindrical portion 61 of the outward member 6, the plural rolling elements 7, the first cage 701, the second cage 702, and the seal member 89. The first portion 611 of the cylindrical portion 61 is formed with a first outer raceway face 611a along which the plural rolling elements 7 of the first rolling element row 71 roll, and a second outer raceway face 611b along which the plural rolling elements 7 of the second rolling element row 72 roll.

In the present embodiment, as illustrated in FIG. 6, the flange portion 62 is made up of plural flange pieces 621, which is provided radially so as to protrude outward from the first portion 611 of the cylindrical portion 61. However, the flange portion 62 may be provided in an annular shape on an outer peripheral side of the cylindrical portion 61. The attachment member 92 has screw holes 92b that are formed opening at the opening end face 920a into which bolts 97 for fixing the flange portion 62, are screwed. The opening end face 920a is an end face of the attachment member 92 on the vehicle outer side around an opening portion of the attachment hole 920. The flange pieces 621 have bolt insertion holes 62a that are formed at positions corresponding to the screw holes 92b. The outward member 6 is fixed to the attachment member 92 by the bolts 97 that are inserted through the bolt insertion holes 62a and screwed into the screw holes 92b.

As illustrated in FIG. 7, the internal gear portion 63 has formed therein plural helical teeth 63a of which tooth traces are inclined with respect to the axial direction. The internal gear portion 63 meshes with helical teeth 3a of the plural planetary gears 3. A bearing fitting portion 612a into which the end portion bearing 80 is fitted is formed at the end portion on the vehicle inner side of the second portion 612 of the cylindrical portion 61.

The end portion bearing 80 is a ball bearing, and as illustrated in FIG. 3, has an outer ring 801, an inner ring 802, and plural rolling elements 803 that are disposed between the outer ring 801 and the inner ring 802. The outer ring 801 is held in the bearing fitting portion 612a of the outward member 6, and a side surface 801a on the vehicle outer side abuts against an end surface 63b on the vehicle inner side of the internal gear portion 63. The inner ring 802 is disposed on an outer periphery of the base portion 411 of the holding member 41, and a side face 802a on the vehicle inner side of the inner ring 802 faces the flange portion 412 of the holding member 41.

The end portion bearing 80 is disposed positioned farther away from the hub unit 13 in the axial direction of the drive device 1 than the internal gear portion 63, and the internal gear portion 63 is provided between the second rolling element row 72 on the planetary gear mechanism 12 side, out of the first rolling element row 71 and the second rolling element row 72, and the end portion bearing 80. Due to this arrangement of the end portion bearing 80, even when moment is applied to the hub unit 13 due to external force acting on the wheel-tire assembly 91 when the vehicle is traveling, causing the hub unit 13 to tilt slightly with respect to the rotation axis 90, the carrier 4 will tilt together with the hub unit 13, whereby the relative tilt between the internal gear portion 63 and the planetary gears 3 can be suppressed. Also, the carrier 4 and the inward member 5 are rotatably supported relative to the outward member 6 at plural positions spaced apart in the axial direction, and accordingly tilt of the carrier 4 and the inward member 5 relative to the outward member 6 can be suppressed. This enables good meshing to be maintained between the internal gear portion 63 and the planetary gears 3.

Note that, in order to maintain good meshing between the planetary gears 3 and the sun gear portion 223a of the reduction rotation member 22 even when the carrier 4 and the inward member 5 are tilted with respect to the rotation axis 90, it is desirable to perform tooth profile correction such as crowning or the like on the sun gear portion 223a.

According to the present embodiment described above, the internal gear portion 63 that meshes with the plural planetary gears 3 is provided on the inner periphery portion of the outward member 6 that is fitted and fixed into the attachment hole 920 of the attachment member 92, and this configuration enables reduction in the size of the drive device 1.

### Additional Notes

Although the present invention has been described above based on the embodiment, the invention according to the claims is not limited to this embodiment. It should also be noted that not all of the combinations of features described in the embodiments are necessarily essential to the means for solving the problem according to the invention. Also, the present invention can be implemented in various modified forms as appropriate, such as by omitting part of the configurations, or by adding or substituting configurations, without departing from the spirit of the invention.

### REFERENCE SIGNS LIST

1 DRIVE DEVICE
10 ELECTRIC MOTOR
101 OUTPUT SHAFT
11 PRIMARY REDUCTION MECHANISM
12 PLANETARY GEAR MECHANISM
13 HUB UNIT
21 PINION GEAR
22 REDUCTION ROTATION MEMBER
222a LARGE-DIAMETER GEAR PORTION
223 SHAFT PORTION
223a SUN GEAR PORTION
3 PLANETARY GEAR
4 CARRIER
5 INWARD MEMBER
501 HUB FLANGE
6 OUTWARD MEMBER
61 CYLINDRICAL PORTION
62 FLANGE PORTION
63 INTERNAL GEAR PORTION
7 ROLLING ELEMENT
71 FIRST ROLLING ELEMENT ROW
72 SECOND ROLLING ELEMENT ROW
80 END PORTION BEARING
90 ROTATION AXIS
91 WHEEL-TIRE ASSEMBLY
92 ATTACHMENT MEMBER
920 ATTACHMENT HOLE

1. A drive device that is attached to an attachment member including an attachment hole that is formed coaxially with a rotation axis of a wheel-tire assembly, and that drives the wheel-tire assembly, the drive device comprising:
an electric motor;
a planetary gear mechanism that reduces speed of output rotation of the electric motor; and
a hub unit that supports the wheel-tire assembly,
wherein the planetary gear mechanism and the hub unit are coaxially disposed in an axial direction along the rotation axis,
wherein the hub unit includes an inward member including a hub flange to which the wheel-tire assembly is attached, an outward member that is fitted and fixed into the attachment hole, and a plurality of rolling elements that are disposed between the inward member and the outward member, the outward member extending around an outer periphery of the planetary gear mechanism,
wherein the planetary gear mechanism includes a plurality of planetary gears, a carrier supporting the plurality of planetary gears, an internal gear portion meshing with the plurality of planetary gears on an outer peripheral side of the carrier, and a sun gear portion meshing with the plurality of planetary gears on an inner peripheral side of the carrier, the carrier being linked to the inward member so as not to rotate relative to the inward member,
wherein the internal gear portion is provided on an inner periphery portion of the outward member,
wherein the drive device further comprises a bearing for rotatably supporting the carrier relative to the outward member, the bearing being disposed at a position farther from the hub unit than the internal gear portion in the axial direction, and
wherein the plurality of rolling elements are disposed between the inward member and the outward member and forms a double row of rolling elements, and the internal gear portion is provided between a rolling element row on the planetary gear mechanism side of the double row of rolling elements, and the bearing.

2-3. (canceled)

4. The drive device according to claim 1, wherein the outward member integrally includes a cylindrical portion that is fitted into the attachment hole, a flange portion that is fixed to an opening end face of the attachment hole in the attachment member, and the internal gear portion.

5. The drive device according to claim 1, further comprising a primary reduction mechanism that is provided between the electric motor and the planetary gear mechanism, wherein:
the primary reduction mechanism is configured by meshing a small-diameter gear portion of a pinion gear that is attached to an output shaft of the electric motor, with a large-diameter gear portion of a reduction rotation member including the large-diameter gear portion of which a pitch diameter is larger than that of the small-diameter gear portion; and
the sun gear portion rotates integrally with the large-diameter gear portion.

6. The drive device according to claim 5, wherein:
the reduction rotation member has a shaft portion that is disposed at a center portion of the carrier, and the sun gear portion is formed on an outer periphery of the shaft portion; and
a pitch diameter of the sun gear portion is smaller than a pitch diameter of the large-diameter gear portion.
